(19) United States
(12) Patent Application Publication
(10) Pub. No.: US 2006/0136844 A1
(43) Pub. Date: Jun. 22, 2006

(54) Method of making a graphic button

(76) Inventors: Hogan Zhang, Dajie Beijing (CN); Pinky Ma, Dajie Beijing (CN); Zechary Chang, Taipei (TW)

Correspondence Address: HDSL, 4331 STEVENS BATTLE LANE, FAIRFAX, VA, 22033, US

(21) Appl. No.: 11/014,587

(22) Filed: Dec. 17, 2004

(51) Int. Cl. G06F 17/00

(52) U.S. Cl. 715/837

(57) ABSTRACT

A method of making graphic buttons for an application program, in which frames under various conditions are provided. Hot keys and texts according to each condition are set up. The application program is then operated to provide a display command. According to the display command, the corresponding frames, hot keys, and texts are retrieved to generate the corresponding graphic buttons in real time. Thereby, the space occupied by the graphic buttons is greatly reduced, and the flexibility and applicability of the graphic buttons are greatly enhanced.

### BACKGROUND OF THE INVENTION

The invention relates to a method of making a graphic button, and more particularly to method of graphitizing a button in an application program.

Aesthetic and user-friendly approaches for an interface are the key conditions for a successful application program. The graphical user interface (GUI) is the common phrase to describe an interactive window, drawings, and functions allowing the user to use a mouse or a keyboard to activate an application program or open a document. For the users, the interface is the application program. They are not aware of the codes executed behind the screen. Therefore, the effort and time consumed in coding cannot be appreciated. The applicability of an application program often relies on the performance of the interface.

Many application programs have adapted graphic buttons to improve the user interface. In terms of the aesthetic approach, the graphic button is used to replace the system recognition button, so as to improve the interface of the application program. To further improve the interface, graphic buttons can be designed with three-dimensional visual effects. That is, the graphic buttons appear to protrude from the screen. When the user clicks the protruding graphic buttons with the mouse, the selected button appears recessed from the screen. When the mouse is released, the button again protrudes from the screen. Some of the buttons may be highlighted to represent activation status, and become gray when they are inactivated.

The conventional method to implement the graphic button includes designing several graphs for each button showing normal conditions, highlighted conditions, and pressed conditions, for example. Each of the graphs includes a hot key and text of the respective button. Thereby, an aesthetic effect is obtained. However, when an application program requires a large number of buttons, implementation of the graphic buttons becomes very labor-intensive and time-consuming. In addition, a large amount of memory space is required by the graphic buttons. The performance of the application program is consequently degraded. It is also almost impossible to edit the graphic button later on. For example, when an application program is edited under the simplified-Chinese platform, all the graphic buttons need to be redesigned for converting the application program into the traditional-Chinese version. The labor for such conversion is significant. Furthermore, the package of such an application program is seriously increased to reduce the application and downloading speed.

It is therefore a substantial need to provide a method of making graphic buttons with a minimized package for an application program, such that the application program can be easily applied and downloaded, while the aesthetic and user-friendly interface can be provided.

### BRIEF SUMMARY OF THE INVENTION

To resolve the above drawbacks, a method of making graphic buttons of an application program is provided. The method reduces the space occupied by the graphic buttons and provides switchable and flexible display patterns of the graphic buttons.

In the method as provided, a plurality of frames for various conditions is provided. According to each of the conditions, hot keys and texts are set up. The application program is operated to provide a display command, and the frames, hot keys, and texts are selected in correspondence to the display command, so as to generate the desired graphic buttons.

By the above method, the graphic buttons are made in real time without occupying a significant amount of space. The package of the application program is thus reduced. Furthermore, the labor and time consumed for each graphic button is greatly reduced. The user can also switch the graphic buttons between various styles.

### BRIEF DESCRIPTION OF THE DRAWINGS

The above objects and advantages of the invention will become more apparent with the following detailed description of the exemplary embodiments thereof with reference to the attached drawings in which:

FIG. 1 shows the process for making the graphic buttons;

FIG. 2A˜2D shows exemplary frames for the graphic buttons;

FIG. 3A˜3D show examples of the graphic buttons; and

FIG. 4 is a flow chart showing the method of making the graphic buttons.

### DETAILED DESCRIPTION OF THE INVENTION

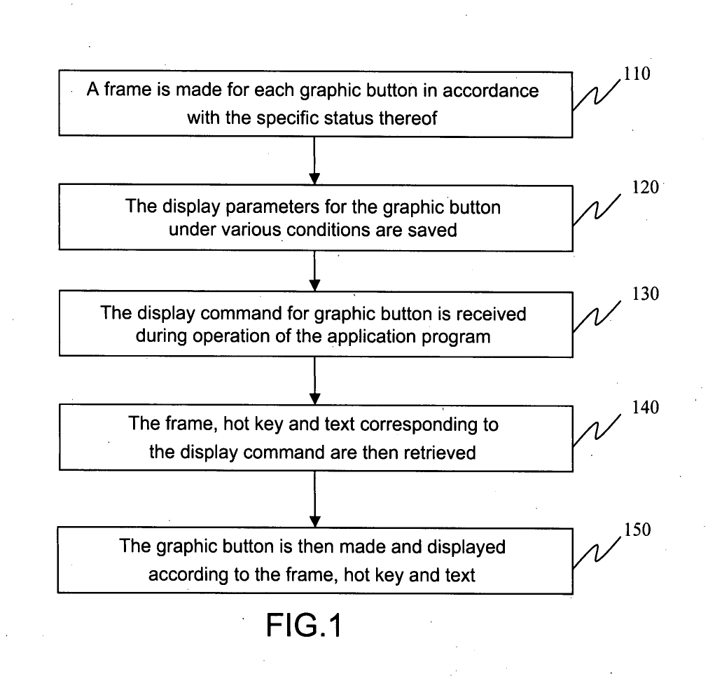

FIG. 1 illustrates the process for making graphic buttons. In step 110, a frame is made for each graphic button in accordance with the specific status thereof. The display parameters for the graphic button under various conditions are saved in step 120. The display command for graphic button is received during operation of the application program in step 130. The frame, hot key and text corresponding to the display command are then retrieved in step 140. The graphic button is then made and displayed according to the frame, hot key and text in step 150.

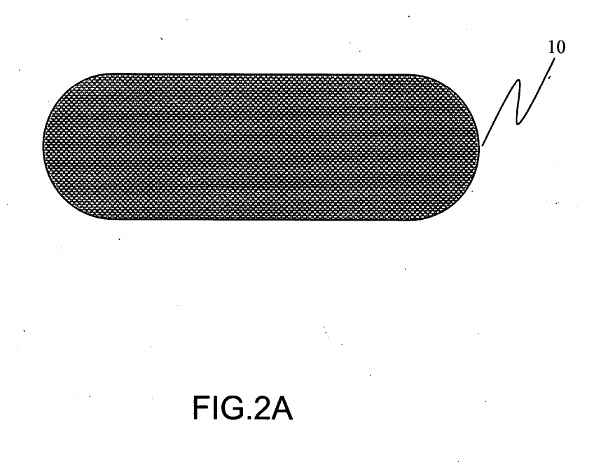

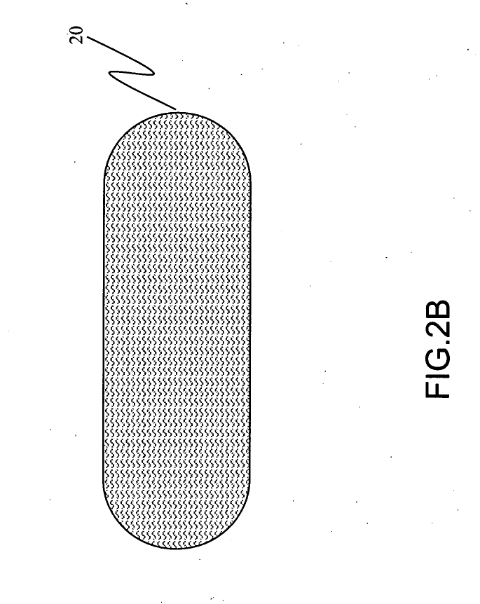

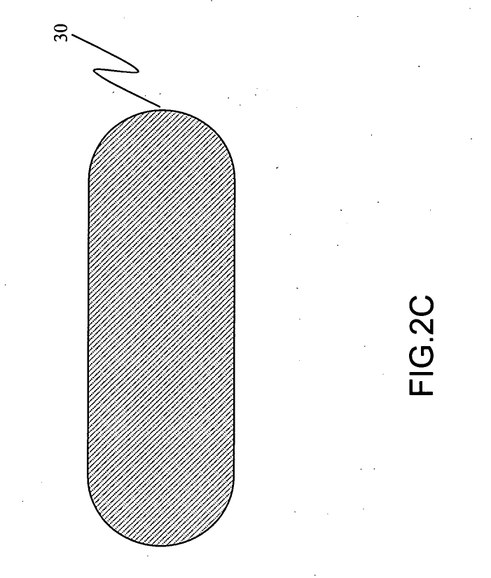

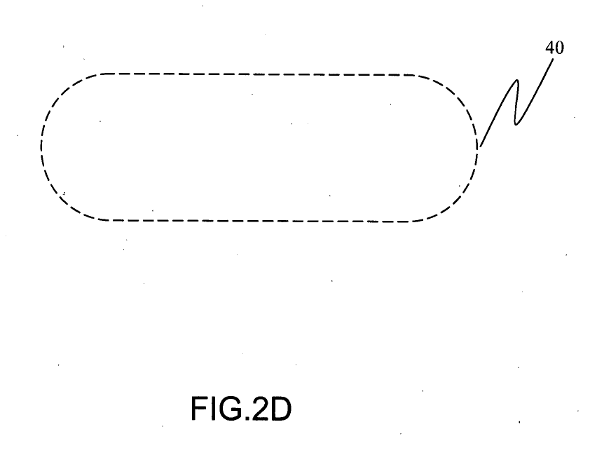

In the method described above, many frames that do not have any content are required. Referring to FIGS. 2A˜2D, the buttons 10, 20, 30 and 40 are designed for the conditions of normal, highlighted, pressed and disabled, respectively. Various sets of frames can be designed in accordance with various conditions to present various styles, so that the user can switch between styles as desired.

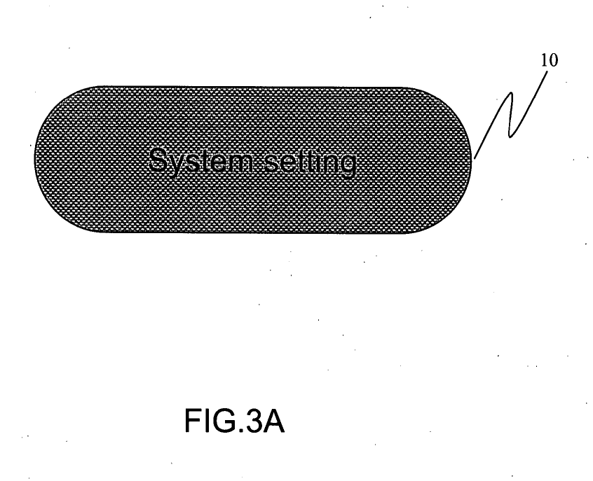

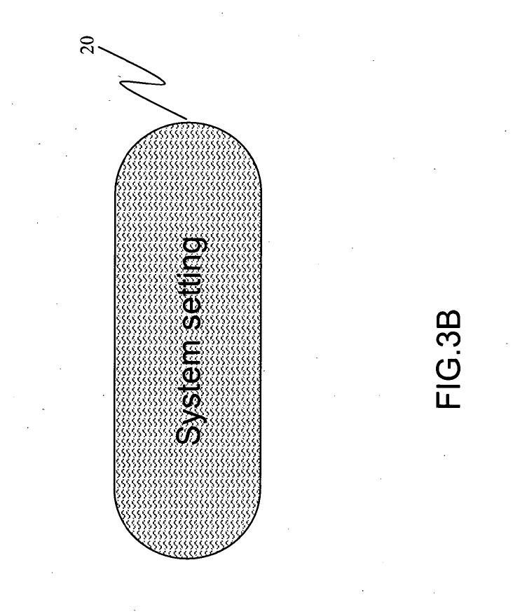

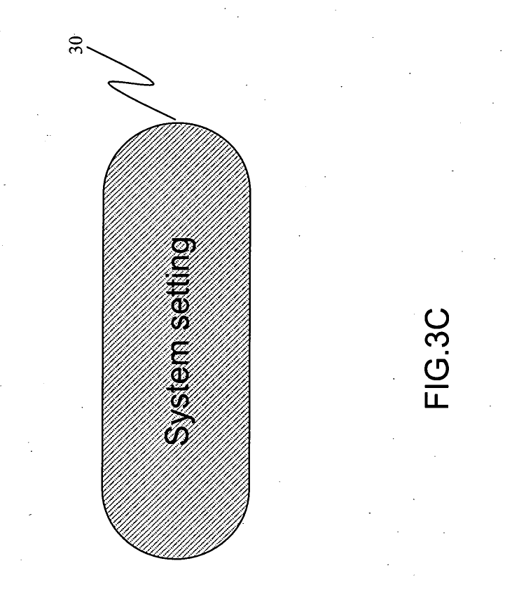

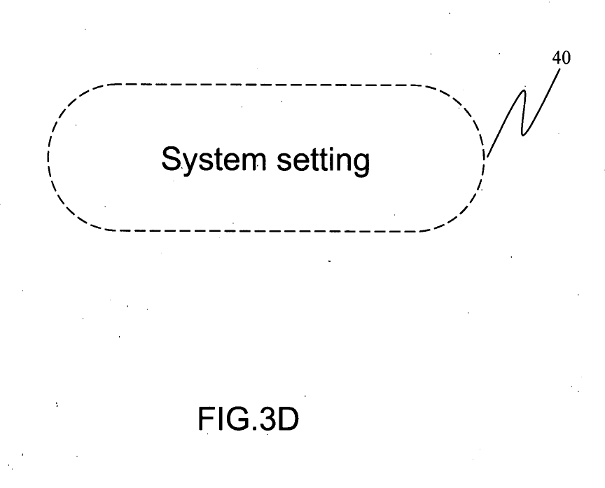

Hot keys and texts are then colored according to predetermined color selections. Thereby, regardless of the number of buttons required by the application program, the graphic buttons can be easily made by applying the hot keys and texts of a specific language version. When the language version is changed, the graphic buttons can be easily change by applying the hot keys and texts designed for the new language version. Thereby, the package of the application program is reduced. Referring to FIGS. 3A˜3D shows the exemplary graphic buttons made by the method provided in this embodiment.

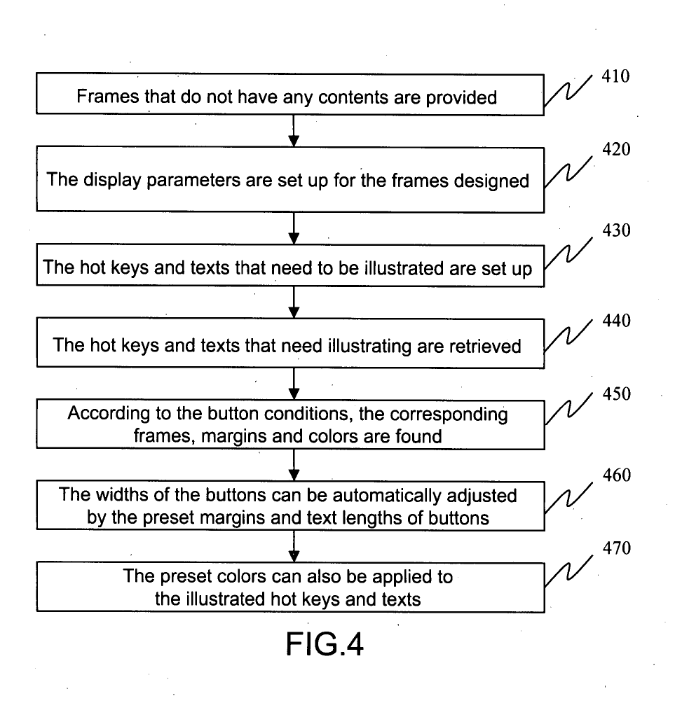

Referring to FIG. 4, each step for making the graphic buttons is illustrated and described in details as follows.

In step 410, frames that do not have any contents are provided. The frames are designed differently to indicate various conditions, including normal, highlighted, pressed, and disabled, for example.

In step 420, the display parameters are set up for the frames designed in step 410. The display parameters include blanks at two sides (margins) and the colors used for hot keys and texts in each condition, such as:

| | |
|---|---|
| <pushbutton type=”default” | margin=”14”> |
| <picture type=”normal” | color=”#333399” |
| paper=”white”>b1.png</picture> | |
| <picture type=”mouseover” | color=”#333399” |
| paper=”white”>b2.png</picture> | |
| <picture type=”down” | color=”#ee7700” |
| paper=”white”>b3.png</picture> | |
| <picture type=”disabled” | color=”#8899aa” |

paper=”#ccddee”>b4.png</picture>

The hint module 160 is used to provide the current network access speed and the cost that may be incurred for visiting a specific website. The user can thus determine whether the website should be visited based on the network performance and the cost, or the amount of time to visit the website.

In step 430, the hot keys and texts that need to be illustrated are set up, such as:

<widgets>
<widget type=”pushbutton” name=”settings” accel=”0”
test=”system setup”/>
<widget type=”pushbutton” name=”help” accel=”9”
test=”instruction”/>
</widgets>

During operation of the application program, the hot keys and texts that need illustrating are retrieved in step 440. According to the button conditions, the corresponding frames, margins and colors are found in step 450. The selection may be made among several sets of frames, so as to design a personalized graphic interface. The widths of the buttons can be automatically adjusted by the preset margins and text lengths of buttons in step 460. The preset colors can also be applied to the illustrated hot keys and texts in step 470.

While the invention has been shown and described with reference to preferred embodiments thereof, it will be understood by those skilled in the art that various changes in form and details may be made therein without departing from the spirit and scope of the invention as defined by the appended claims.

What is claimed is:

1. A method of making and generate graphic buttons during operation of an application program, comprising:
providing a plurality of frames under various conditions;
setting up at least one hot key and at least one text for each of the graphic buttons under each condition;
executing the application program to receive a display command of the graphic buttons;
retrieving at least one of the frames, one of the hot keys and one of the text corresponding to the display command; and
generating the graphic buttons according to the retrieved frame, hot key and text corresponding to the display command.

2. The method of claim 1, wherein the step of setting up at least one hot key and at least one text for each of the graphic buttons under each condition further comprising:
saving display parameters of the graphic buttons under the conditions; and
displaying the display parameters to adjust the graphic buttons.

3. The method of claim 2, wherein the display parameters include colors of the hot keys, texts and margins of the texts.

4. The method of claim 1, further comprising dividing the frames into a plurality of groups and selecting the group of frames desired by the user.

5. The method of claim 1, wherein the conditions include normal, highlighted, pressed, and disable.

6. The method of claim 1, wherein the frames are made in real time.
